(19) United States
(12) Patent Application Publication
(10) Pub. No.: US 2014/0058588 A1
(43) Pub. Date: Feb. 27, 2014

(54) DEVICE FOR CONFIGURING A MOTOR VEHICLE

(71) Applicant: GM Global Technology Operations LLC, Detroit, MI (US)

(72) Inventors: Stephane VITET, Frankfurt am Main (DE); Peter KAHLER, Nierstein (DE)

(73) Assignee: GM GLOBAL TECHNOLOGY OPERATIONS LLC, Detroit, MI (US)

(21) Appl. No.: 13/974,656

(22) Filed: Aug. 23, 2013

(30) Foreign Application Priority Data
Aug. 24, 2012 (DE) 10 2012 016774.1

(51) Int. Cl. G06F 17/00

(52) U.S. Cl. CPC G06F 17/00
USPC 701/2; 701/1

(57) ABSTRACT

A device is provided for configuring a motor vehicle, which makes possible the setting of a plurality of operating parameters, with a control that is connected to a plurality of configurable vehicle systems, and with an input device that can be operated by a user, which is connected or can be connected to the control and via which inputs for configuring the vehicle systems can be carried out. It is provided that the input device comprises a monitor, which displays an input mask with a plurality of slide controllers, where each slide controller serves for setting a certain operating parameter of the motor vehicle.

### CROSS-REFERENCE TO RELATED APPLICATION

This application claims priority to Patent Application No. 10 2012 016 774.1, filed Aug. 24, 2012, which is incorporated herein by reference in its entirety.

### TECHNICAL FIELD

The technical field relates to a device for configuring a motor vehicle that makes it possible to set a plurality of operating parameters. The device comprises a control that is connected to a plurality of configurable vehicle systems, and an input device for configuring the vehicle systems.

### BACKGROUND

It is known in the prior art that vehicle systems and vehicle components can be configurable by an operator, e.g., a driver. As a rule, this includes settings regarding air-conditioning, e.g., temperature, ventilation, air-conditioning system and for media playback, e.g., volume, radio frequency etc. even in basically equipped motor vehicles. It is known furthermore to set other vehicle characteristics, for example, the suspension by way of suspension hardness and vehicle level or the transmission characteristic, e.g., in the case of an automatic transmission, winter mode, sporty or comfortable.

In modern motor vehicles it is known in addition to combine such functions in a common user interface. Such can be realized for example by means of a rotary-push actuator, these or a touch-sensitive monitor. The inputs are then processed by a vehicle control and the corresponding setting of the operating parameters carried out. The operating functions are mostly arranged hierarchically so that the user has to work through a plurality of menu levels in order to change the desired settings. This is uncomfortable and not intuitive.

From DE 103 34 587 A1 a method for influencing the characteristic and tuning of a motor vehicle by means of variable vehicle functions is known, in which out of the quantity of the variable vehicle functions, two or more function clusters are formed, where each function cluster is a genuine part quantity of the quantity of the variable vehicle functions, the part quantities defining the function clusters are disjoint, each function cluster is assigned one or a plurality of cluster parameters and the vehicle functions of a function cluster are changed with the cluster parameter. For inputting, slide controllers for a function cluster each are provided, which serve for manipulating the relevant function cluster. The operation thus takes place at a higher user level. Converting the settings into internal system parameters is then carried out with the help of suitable tables or similar.

It is at least one object to further develop a device of the type mentioned at the outset such that an intuitive operation of configurable motor vehicle parameters is possible. In addition, other objects, desirable features and characteristics will become apparent from the subsequent summary and detailed description, and the appended claims, taken in conjunction with the accompanying drawings and this background.

A device according to an embodiment serves for configuring a motor vehicle which makes possible the setting of a plurality of operating parameters. These operating parameters can include, for example, interior air-conditioning, spin suspension and damping, steering, transmission control, engine control, exhaust system control, lighting, interior lighting and the like. The device comprises a control that is connected to a plurality of configurable vehicle systems, for example the previously mentioned vehicle systems. The control can be designed as a separate control module, but also as part of a motor vehicle control. The connection to the vehicle systems can be carried out in a manner known per se, for example with an installed data bus system.

The device, furthermore, comprises an input device that can be operated by a user. By way of the input device, inputs regarding the configuration of the vehicle systems can be carried out. The input device can be connected or is connected to the control in a signal or data conducting manner, so that the control commands input via the input device can be passed on to the control. The input device to this end is connected to the control in particular in a bi-directionally data-conducting manner. For data transmission, a data bus system can be used according to a configuration.

The input device comprises a monitor that depicts an input mask with a plurality of slide controllers, where each slide controller serves for setting a certain operating parameter of the motor vehicle. The operating parameter can be a direct operating parameter or a parameter at a super ordinate level. In the case of an operating parameter at a super ordinate level, a conversion to the level of the vehicle systems can be carried out via tables or other suitable device, for example characteristic maps.

Thus, the sportiness of the vehicle tuning can for example be set via a single slide controller. A sporty setting has influence on a plurality of vehicle systems: the response behavior of the engine can be set for example to be more direct so that it reacts more quickly and more aggressively to accelerator pedal actuations. The steering can be set more directly so that the steering lock is reduced. The chassis can be set harder and with less ground clearance and the exhaust system can be adjusted to a robust sound. In addition to this, the transmission control can be suitably adapted so that the shifting times and the shifting behavior fit in with the desired driving style.

Intuitive vehicle operation is made possible for the driver. The function of the slide controller is accessible to most users directly or with a short learning time. In addition, slide controllers can be displayed in a space-saving manner so that a plurality of operating possibilities can be simultaneously displayed on the input mask. The number or required menu levels can thereby be reduced to a minimum and the operation of the motor vehicle compared with conventional menu-based input possibilities, simplified.

This is true in particular since most displays are installed in landscape format, for example in the format 4:3 or 16:9. Conventional menu levels, which are displayed below one another, use up a large part of the vertical space available, whereas slide controllers can be arranged as is helpful for optimal space utilization, in landscape format for example through a plurality of slide controllers arranged next to one another.

According to an embodiment, it can be provided that the monitor of the input device is touch-sensitive. Thus, the input can be performed directly on the slide controllers displayed on the monitor in a particularly intuitive manner. According to a further embodiment it can be provided that a storage unit for storing a plurality of motor vehicle profiles is provided. In this way, the configuration can be simplified since with a corresponding motor vehicle profile the setting of a plurality of vehicle systems is possible at the same time.

In a further embodiment it can be provided that the motor vehicle profiles are predetermined and/or individualizable. Thus, different topics can be preconfigured, such as comfortable or sporty for example. Additionally or alternatively, the users of the motor vehicle can predetermined their own settings which deviate from the preconfigured topics. Thus, a driver can for example set the chassis of the vehicle softer with sporty tuning if he should find a particularly hard setting unpleasant.

According to a further embodiment it can be provided that the input device is mobile. The input device in this configuration can be removed from the vehicle. This can for example serve for removing the input device from a parked vehicle for anti-theft purposes. In addition, the input device can have further functions, which can be operated away from the vehicle, e.g., activation or deactivation of an alarm system, shutting down the vehicle or activating or deactivating an independent heater. Furthermore, the input device can then also be used in other vehicles when suitably configured so that a simple transfer of the personal settings from the input device to the other vehicle is possible.

According to a further embodiment it can be provided that in addition to the mobile input device a further, non-mobile input device is provided in the vehicle. The mobile input device can then complement and expand the functionality of the non-mobile input device. Thus, the permanently installed input device can have a simpler, lower-resolution monitor, the mobile input device a higher-resolution monitor, which makes possible a more comfortable display and operation of a larger number of functions.

Furthermore, the input device can be used for further functions which are independent of the motor vehicle in a configuration of the invention. An input device within the scope of this configuration can for example be realized through a mobile phone with a corresponding display or a tablet computer. The input device is then provided for example via a suitable program (“app”) stored on the mobile phone or tablet computer, which is loaded for the vehicle operation.

According to a further embodiment, it can be provided furthermore that the input device can be connected to the control with wireless data transmission. This can be affected via standards known per se, such as for example WLAN, Bluetooth, GSM or the like.

According to a further embodiment it can be provided that the input device comprises an identifier. Different operators can have different input devices and each input device can thus be assigned one or a selection of possible users. Thus, certain favored settings and/or display modes can be loaded from the memory and be offered for selection. In addition to this it is thus possible that an operator still has access to a plurality of vehicles, for example from a vehicle pool, finds the same basic settings in all vehicles without having to newly set each vehicle to suit the driver's requirements.

According to a further embodiment it can be provided that the input mask is individualizable. With respect of the display used, this can apply for example with respect to colors, display size of the slide controllers etc., but also with respect to the selection of the offered setting options. Thus, the various degrees of individualization wishes of the operators can be accommodated.

According to a further possible embodiment it can be provided that the input device comprises an input wheel or another input element, which can be optionally assigned to a slide controller. Thus, an operator can sequentially select and set the respective parameters shown. According to a further embodiment it can be provided that different setting levels are provided, by means of which settings can be carried out generally or specifically. Thus, a certain desired driving behavior can be generally adjustable and specifically certain function groups, which influence the driving behavior, adjusted.

### BRIEF DESCRIPTION OF THE DRAWINGS

The present invention will hereinafter be described in conjunction with the following drawing figures, wherein like numerals denote like elements, and:

FIG. 1 is a motor vehicle equipped according to an embodiment; and

FIG. 2 is a representation of an input mask of an input device of a motor vehicle equipped according to an embodiment.

### DETAILED DESCRIPTION

The following detailed description is merely exemplary in nature and is not intended to limit application and uses. Furthermore, there is no intention to be bound by any theory presented in the preceding background or summary or the following detailed description.

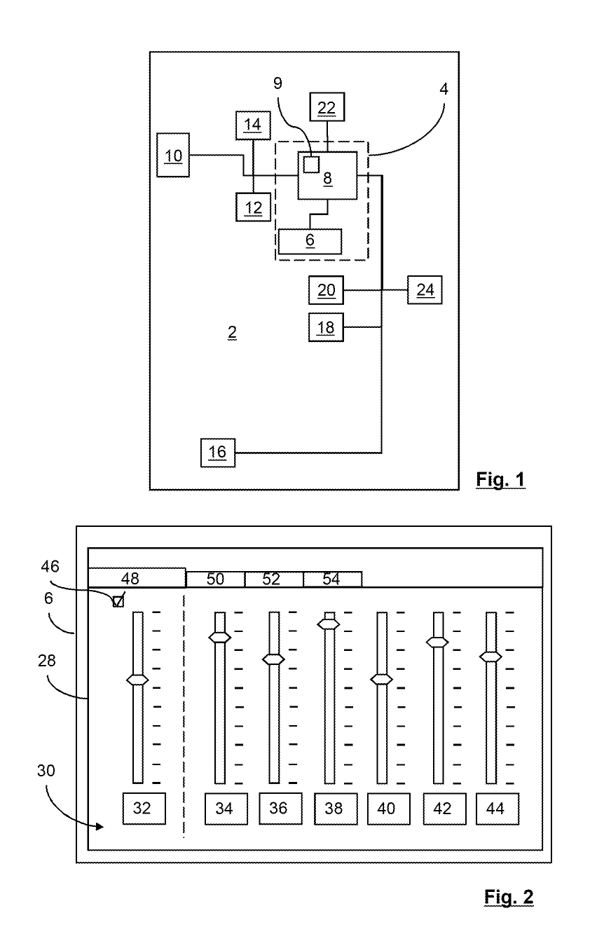

FIG. 1 schematically shows a vehicle 2 in a top view equipped according to an embodiment of the invention; in the motor vehicle 2, a device 4 (framed in interrupted line) is provided for configuring the motor vehicle 2. The device 4 comprises an input device 6 and a control 8. The configuration of the input device 6 is explained in more detail in connection with FIG. 2.

The input device 6 is connected to the control 8 in a signal-conducting manner. Here, the connection is realized with a vehicle-internal bus system, but can also be realized wirelessly, e.g., via WLAN, Bluetooth or other communication media in alternative embodiments. The signals can be bi-directionally exchanged between input device 6 and control 8.

The input device 6 constitutes a user interface that allows a user for example a driver of the motor vehicle 2 to configure the motor vehicle 2 to suit his ideas and wishes. Here, the control 8 is realized as a central motor vehicle control, in which many functions and operating states of the motor vehicle can be set, monitored, controlled and regulated. The control includes a memory 9, in which predetermined and user-created settings or profiles can be stored.

The control 8 is connected to a multiplicity of motor vehicle modules and units, in particular with a chassis 10, a steering 12, an engine control 14, an exhaust system 16, a vehicle interior lighting 18, a media module 20, a transmission control 22 as well as an air-conditioning 24. The control 8 can be connected with further modules, which are not shown here, for example a seat module. The previously shown selection is exemplary for modules and units which can be configured in some motor vehicles.

Following input of a configuration via the input device 6, the relevant information is passed on to the control 8 and processed by the control 8. The input can take place at different abstraction levels such as is shown in the following in connection with FIG. 2. Thus, an input command could be that the chassis is to be tuned to “sporty”. This can be achieved in that both the damper rates as well as the vehicle level are adapted. A further example is that the degree of the support by the driver assistance system is to be set between “deactivated”, “warning” and “intervention”. Such a setting could influence the ABS, driving stability programs, distance warnings, lane keeping assistance and the like.

FIG. 2 shows a representation of a monitor 28 with an input mask 30 of the input device 6 of the motor vehicle 2 equipped according to the invention. The monitor 28 in the exemplary embodiment shown here is a permanently installed touch-sensitive monitor in landscape format, via which by touching the screen surface, operating commands can be input. On the input mask 30, a plurality of slide controllers 32 to 44 are arranged parallel to one another particularly aligned. The slide controllers 32 to 44 can be shifted within the shown range for setting certain functions.

Among the slide controllers 32 to 44, the slide controller 32 is set apart a little further from the remaining slide controllers 34 to 44 and can serve for setting a super ordinate function or a corresponding target. The setting of the remaining slide controllers 34 to 44 depends on the setting of the slide controller 32. For as long as these are set according to the target, this can be displayed by a marking 46.

The slide controllers 32 to 44 can be assigned to a certain function range, e.g. the vehicle characteristic. To this end, the slide controllers 32 to 44 are arranged on a tab 48. Further tabs 50 to 54 depict other function ranges, e.g., air-conditioning, audio or safety settings. When the tab 48 as in the present exemplary embodiment serves for setting the vehicle characteristic, the slide controller 32 can reflect the general characteristic on a scale between “comfortable” and “sporty”. Slide controller 34 then serves for example for setting the chassis hardness between “soft” and “hard”, slide controller 36 for setting the chassis height between “high” and “low”, slide controller 38 for setting the engine characteristic between “normal” and “direct”, slide controller 40 for setting the transmission characteristic between “normal” and “sporty”, slide controller 42 for setting the steering between “indirect” and “direct” and slide controller 44 for setting the exhaust system between “quiet” and “loud”.

If the slide controller 32 is shifted in the direction of “sporty”, the slide controllers 34 to 44 correspondingly move according to an internal target. For as long as the settings of the remaining slide controllers 34 to 44 correspond to the target, this is displayed through an active marking 46. The user is able to change the individual slide controllers 34 to 44 to suit his wishes and adapt the vehicle characteristic. When this is done, such is likewise represented by the marking 46, which is then deactivated for example.

On the input mask 30, further keys and functions can be provided, which will not be discussed in detail here, e.g., for changing to a next higher menu level or for storing settings as presettings predetermined by the user. The next higher menu level can be correspondingly structured or have a conventional structure with actuating fields for the individual sub-groups, which are then shown in the tabs. The device can generally include further functions, which for example are connected with the management of the settings or with the representation. Thus, different users can be created and their profiles stored in the memory 9. It can be determined to which detail degree the user wishes to influence settings. It can be additionally provided which representation options the user wishes, e.g., based on the colors or the arrangement of the slide controllers 32 to 44. In other embodiments with a mobile input device not shown here it can be provided that personal settings can be transferred from the vehicle to the mobile input device and vice versa, so that a user can easily transfer the settings to other vehicles.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A device for configuring a motor vehicle setting of a plurality of operating parameters, comprising:
an input device that is configured for operation by a user to carry out configuration of a plurality of configurable vehicle systems; and
a control that is connected to the plurality of configurable vehicle systems and connected the input device
wherein the input device comprises a monitor that is configured to display an input mask with a plurality of slide controllers
wherein each slide controller of the plurality of slide controllers serves to a certain operating parameter of the motor vehicle.

2. The device according to claim 1, wherein the monitor of the input device is touch-sensitive.

3. The device according to claim 1, further comprising a memory that is configured to store a plurality of motor vehicle profiles.

4. The device according to claim 3, wherein the plurality of motor vehicle profiles are predetermined vehicle profiles.

5. The device according to claim 1, wherein the input device is mobile.

6. The device according to claim 5, further comprising a non-mobile input device in addition to the input device.

7. The device according to claim 5, wherein the input device is connected to the control by wireless data transmission.

8. The device according to claim 5, wherein the input device comprises an identifier.

9. The device according to claim 1, wherein the input mask is individualizable.

10. The device according to claim 1, wherein the input device comprises an input element that is assigned to a first slide controller of the plurality of slide controllers.

11. The device according to claim 1, wherein a plurality of setting levels are available by which settings are carried out.

12. The device according to claim 3, wherein the plurality motor vehicle profiles are individualizable vehicle profiles.

13. The device according to claim 1, wherein the input device is an input wheel.
